(19) United States
(12) Patent Application Publication
(10) Pub. No.: US 2006/0137476 A1
(43) Pub. Date: Jun. 29, 2006

(54) Apparatus for testing tension of elongated flexible member

(76) Inventors: Desmond K. Bull, Christchurch (NZ); Christopher J. Allington, Christchurch (NZ); Richard J. Newton, Kaiapoi (NZ)

Correspondence Address: STITES & HARBISON, PLLC, 400 W MARKET ST, SUITE 1800, LOUISVILLE, KY, 40202-3352, US

(21) Appl. No.: 10/525,846

(22) PCT Filed: Aug. 29, 2003
(86) PCT No.: PCT/NZ03/00191

§ 371 Date: Aug. 26, 2005

(30) Foreign Application Priority Data
Aug. 30, 2002 (NZ) 521094

(51) Int. Cl. G01L 5/04

(52) U.S. Cl. 73/862.393

(57) ABSTRACT

A handheld apparatus (2) for checking the tension of the wire (15) includes a support (3) with two spaced pegs (5,6) mounted on it. A spring (7) mounted on the support (3) between the two pegs. A strain gauge (14) is mounted on the spring and measures the displacement of the spring (7). A fully portable power supply is connected to a computer (9) with a readout (8). In use, the wire (15) is arranged in a predetermined path over and/or under the pegs (5,6) so that it presses against the spring (7). The amount the spring (7) is displaced, which is related to the tension, is measured by the signal from the strain gauge. The signal is passed to the computer (9), which calculates the tension from this measurement and displays the result on the readout (8).

### TECHNICAL FIELD

The present invention relates to apparatus for testing the tension of elongated flexible members such as wires (including, but not limited to, fencing wires, agricultural and horticultural support wires, power wires and telephone wires), wire ropes, mesh fencing and ropes. For the sake of brevity and convenience, the term “wire” will be used herein to include all elongated flexible members.

There are many applications in which it Is desirable to be able to check the tension of a wire whilst the wire is in use, without removing or damaging the wire. For example, if the wire strands of a fence or the support wires in a vineyard are strained too tightly, the wire will be damaged and is likely to fracture prematurely. However, if the wires are under strained, they will not form an effective fence or support the vines correctly.

Often, the tension of the wires needs to be checked in remote locations, where electrical power is not available and where conditions may be less than ideal:- wet, muddy, and with access to the wires impeded by vegetation. Thus, the apparatus needs to be self-contained (i.e. have its own power source), convenient for handheld use, and capable of giving an accurate reading under field conditions.

### BACKGROUND ART

At present, the only apparatus commonly used for checking tension of agricultural and horticultural wires in situ is a hand-held device which is hooked over the wire to be tested, and the wire to be tested is deflected by a preset distance. The deflected wire pushes downwards on a coil spring, deflecting a pointer connected to the spring over a scale. The degree of deflection gives a rough indication of the wire tension. The apparatus is wholly mechanical and thus does not require electrical power, but unfortunately the apparatus is awkward to use, since the reading must be made when the apparatus is actually in position on the wire. Also, the apparatus is notoriously inaccurate:—it is known to read with errors of up to 300 percent.

Another known apparatus is manufactured by Proceq SA and is marketed as a “Wire Tension Meter” stated to be capable of giving a very accurate measurement of the tensile force in highly stressed wires. This apparatus is operated by connecting a central portion onto the wire to be measured and then manually applying a force by means of a screw handle to apply a predetermined deflection to the wire. The apparatus is linked to a computer which compares the readings from the wire with reference values for the preselected wire diameter and type, to give a tension reading for the wire. Whilst this apparatus is said to give very accurate measurements, it Is relatively complex and expensive and is not designed for use in unfavourable conditions or where access to the wire is difficult.

Further, a number of devices have been proposed for measuring the tension of very flexible components, for example, WO 98/51545 which relates to device for measuring the tension of a passenger seat belt in a vehicle; and U.S. Pat. No. 4,759,226 and European Patent 908412, both of which relate to a device for measuring the tensile force on a thread during manufacture. None of these devices are handheld, or indeed portable, and none of them is suitable for measuring the tension of wires (which are only slightly flexible) in situ.

U.S. Pat. No. 4,548,085 discloses a device for measuring the forces due to tension in at least two directions of a flexible linear material. One of the embodiments (FIG. 3) is stated to be portable, although its dimensions and proportions are such that it is difficult to see how it could be used as a fully portable hand-held device. However, the device clearly is designed only for very flexible material and is not self-contained, i.e. it is not designed for, or suitable for, use in the field.

### DISCLOSURE OF INVENTION

It is therefore an object of the present invention to provide an apparatus which can be used for checking the tension of a wire in situ, is capable of providing an accurate reading under field conditions, and which is quick and convenient to use, fully self-contained, and relatively inexpensive to manufacture.

The present invention provides handheld apparatus for checking the tension of a wire, including:

a support having two spaced pegs rigidly secured thereto;

a spring mounted on the support between the two pegs;

the spring and the pegs being arranged such that a wire passing in a predetermined path over and/or under the spring and the pegs is deflected from its normal position and exerts a pressure on the spring in a predetermined direction;

a displacement measuring device associated with the spring and adapted to measure the displacement of the spring when a wire is in said predetermined path;

preprogrammed computing means electrically connected to the displacement measuring device and adapted to display upon a read out a reading for the tension upon the wire when the wire is in said predetermined path;

the computing means being connectable to a fully portable electrical power source.

Preferably, a housing for the electrical power source is Incorporated in the support.

Preferably, the support is an elongated member (which may be of bar or of plate, but preferably a hollow bar) with a handle portion at one end, the length of a handle portion being inclined at an acute angle to the length of the remainder of the support. If hollow bar is used for the support, the housing for the electrical power source conveniently is formed within the handle portion.

Preferably, said pegs are arranged to lie at different levels In a plane parallel to the plane of the support, with the spring between them. In use, a wire to be tested passes under the lower peg and over the upper peg, and presses downwards on the upper surface of the spring. However, many alternative arrangements are possible, since the only requirement is that the wire to be tested can be deflected around the pegs and press the spring in a predetermined direction. For example, both pegs could lie parallel (i.e. at the same level) in the same plane with the spring between the pegs but vertically above the pegs, and wire to be tested could be arranged to pass under the first peg, over the top of the spring and under the second peg.

As used herein, the term “peg” includes a protrusion, a notch, a hook or similar connector or a slot.

The displacement measuring device may be any suitable device capable of measuring the displacement of the spring e.g. a strain gauge or a load cell, a linear or rotary potentiometer, or a linear or rotary encoder.

### BRIEF DESCRIPTION OF DRAWINGS

By way of example only, a preferred embodiment of the present invention is described in detail with reference to the accompanying drawings, in which:

FIG. 1 is a plan view of apparatus in accordance with the present invention;

FIG. 2 is a side view of the apparatus of FIG. 1, in use; and

FIG. 3 is a view of part of FIG. 2, on a larger scale.

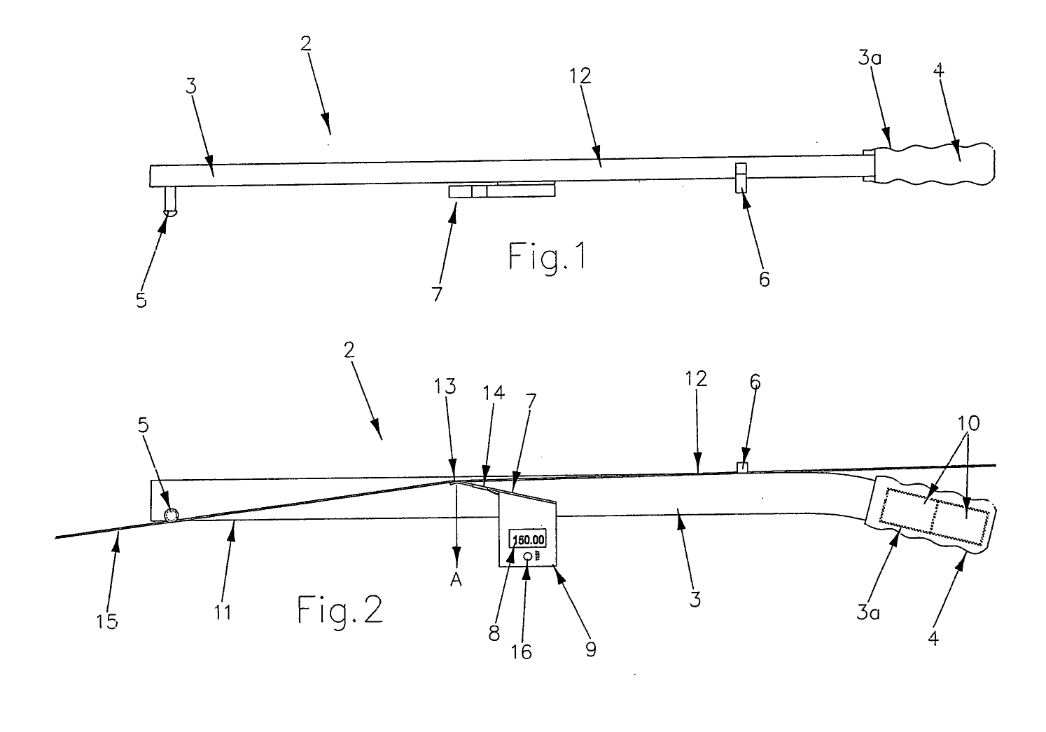

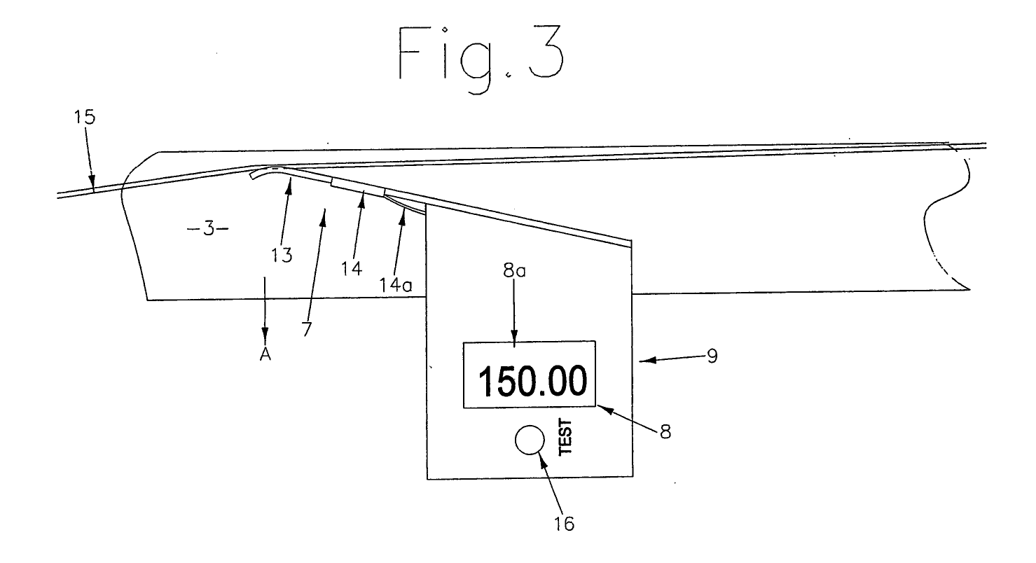

### BEST MODE FOR CARRYING OUT THE INVENTION

Referring to the drawings, apparatus 2 in accordance with the present invention comprises a support 3 formed with a handle 4 at one end, and supporting two spaced pegs 5,6, a spring 7, and a computer (not visible) with an electronic read out 8 mounted in a housing 9.

The support 3 comprises a long hollow bar the major portion of which is straight but the handle end 3a of which is inclined at an acute angle to the length of the major portion of the bar. Each end of the bar is closed by a plastic plug (not shown) of known type. The inside of the handle end 3a of the bar provides a housing for electric batteries 10 for powering the computer and electronic read out 8. The handle 4 is a simple “bicycle grip ” type handle made of rubber or plastics material, which is a push fit over the handle end 3a of the bar.

The pegs 5,6 both are mounted on one side face of the support 3, widely spaced apart along the length of the support. Peg 5 is mounted adjacent the outer end of the support (i.e. the end furthest from the handle end 3a), close to the lower side 11 of the support. Peg 6 is mounted close to the handle end 3a of the support, adjacent the upper side 12 of the support. Preferably, peg 6 is formed as a hook so that the apparatus 2 can be temporarily secured to a wire is tension is to be measured.

The spring 7 comprises a strip of spring steel, one portion of which is rigidly secured to the top of the housing 9, leaving the other portion 13 of the spring projecting unsupported from the top of the housing. The free end of the portion 13 is curved downwards slightly, to prevent the spring from snagging on a wire being tested. The top of the housing 9 slopes at an acute angle to the length of the support 3, so that the spring 7 also slopes at an acute angle to the length of the support 3, with the highest point of the spring (just before the downwardly curved portion) lying just below the upper side 12 of the support 3 and the upper surface of the hook 6. Advantageously, the spring 7 is kept below the upper side 12 of the support 3, to protect the spring from damage.

A displacement measuring device in the form of a strain gauge 14 is secured to the underside of the portion 13 of the spring 7; the strain gauge 14 is electrically connected to the computer by wires 14a extending through an aperture in the side of the housing 9. The strain gauge 14 is arranged to measure the strain on the lower surface of the spring 7; thus, the greater the deflection of the spring 7 in the direction of Arrow A, the greater the reading on the strain gauge.

The apparatus of the present invention, measures the tension in a wire by measuring the force required to deflect the wire. In use, the apparatus is arranged so that the wire 15 whose tension is to be measured lies underneath the peg 5 and hooked underneath the hook 6, so that the wire 15 presses on the upper surface of the portion 13 of the spring 7, deflecting the portion 13 in the direction of Arrow A. The greater the tension in the wire, the more force will be required to deflect it to pass under the peg 5 and hook 6, and thus the greater the deflection of the spring 7. The fact that the handle 4 is inclined at an angle to the remainder of the support means that the apparatus can be secured to the wire 15 whilst keeping the user's hand clear of the wire.

The length of the portion of the wire which is deflected (i.e. the distance between the peg 5 and the hook 6) is not critical, providing the length remains constant from one test to the next, and providing the length is known when calculating the reference figures as described below. Obviously, if the length of the portion of wire is very long, there will be a relatively low force on the spring 7, which will tend to reduce the accuracy of the readings. Conversely, if the length of the portion of wire is very short, there will be a high force on the spring 7 but it may be difficult to manipulate the wire over/under the pegs because of the stiffness of the wire. For testing the tension in fencing and horticultural wires, a support 3 which provides 500 mm between the centres of peg 5 and hook 6 has been found to be a convenient length.

Preferably, the spring 7 has a flexibility in the range 0.0016 mm/Newton-0.043 mm/Newton, since this permits the apparatus to offer some compensation for the different stiffnesses of wire whose tension is to be measured. For any given length of wire, the overall stiffness of the wire is a combination of the inherent or initial stiffness of the wire plus the additional stiffness caused by the tension applied to the wire. The apparatus must be capable of measuring the tension of wires with a wide range of inherent stiffness and with a wide range of tension applied to the wire. The flexibility of the spring 7 allows it to deform when the apparatus is placed in the testing position on the wire, so that if the apparatus is used to test a wire which has a very high inherent stiffness and/or a high tension applied to it, the deformation of the spring 7 means that the wire under test needs to deform less to pass through the apparatus i.e. the path of the wire through the apparatus is “flatter”. This is important if the apparatus is to be used with very stiff wires, because otherwise it may be physically impossible to engage the apparatus with a wire, or the wire may be damaged by engaging it with the apparatus.

If the apparatus is used to test less stiff wires (i.e. either lower inherent stiffness and/or a lower tension applied to the wire) then the spring 7 deforms less.

The flexibility of a spring (or any member) is a measure of the deflection per load applied. The spring 7 acts like a cantilever beam so the deflection is:

$$Δ = \frac{{PL}^{3}}{3 EI}$$

Where:

P=Applied point load

L=Length of the member to the applied load

E=Modulus of Elasticity of the member

I=Second moment of area of the section. (bd³/12 for a rectangular section, where b=width and d=depth)

Therefore the flexibility (deflection/load) is:

$$Δ = \frac{{L}^{3}}{3 EI}$$

In the preferred embodiment illustrated in the drawings, these parameters have the following values:

L=30 mm

b=12.5 mm

d=1.6 mm

E=200,000 MPa or N/mm²
This gives a value of Δ=0.0105 mm/Newton. However, the acceptable range of spring flexibility for a majority of applications is 0.0016 mm/Newton-0.043 mm/Newton.

The computer comprises a surface mounted circuit board which incorporates programmable integrated circuits, a screen 8a from which the user can read a figure for the wire tension, and a three function button 16 which can be used to switch the apparatus on and off, to clear the screen and zero the readings, and to scroll through a list of the available wire types for which the apparatus is programmed, and to select the required type. The circuit may also include a buzzer which is programmed to sound when the tension of a wire being measured reaches a preselected value.

The data from Which the integrated circuits are programmed are obtained experimentally by testing multiple samples of each type of wire with which the apparatus is to be used, to obtain a series of readings for wire tension/strain gauge voltage. The test figures for each set of samples are statistically analysed to give a set of reference figures for wire tension/strain gauge voltage for each type of wire with which the apparatus Is to be used, corrected for the initial (inherent) stiffness of the wire. These reference figures are then programmed into the integrated circuit such that when the apparatus is preset for a specified type of wire, the strain gauge reading is automatically converted to a wire tension reading which can be read directly off the screen.

It is envisaged that the apparatus typically would carry data for at least eight different types of commonly used wire. However, the apparatus could be recalibrated as necessary for different applications.

The screen 8a can be arranged to record each reading until the display is zeroed by the user. Thus, the apparatus can be used to measure the tension in a wire and then removed from the wire and lowered or raised to a convenient reading height for the user to read from the screen, without losing the reading. The screen reading shows the wire type for which the apparatus is set, including the diameter of the wire. The screen reading also shows the optimal tension for that type of wire, based on the manufacturer's recommendations and the actual tension of the wire being tested. Thus, the user can compare the tension of the wire being tested with the optimal tension recommended by the manufacturer, for every test being made.

All of the electrical/electronic components in the apparatus are waterproofed.

The support 3 and the housing 9 may be made of any suitable robust, impact resistant material, e.g. anodized aluminium, coated steel, fibre reinforced resins or an impact resistant plastics material.

The support 3 can be made of flat plate rather than hollow bar, with the housing for the batteries secured to one side of the plate.

The spring 7 can be made from any suitable material which has a flexibility within the required range and which remains in the elastic portion of the stress/strain response in the conditions of use. Suitable materials include steels (mild/stainless/spring) aluminium, fibre reinforced resins, and impact resistant plastics.

1. Handheld apparatus for checking the tension of a wire, including: a support having two spaced pegs rigidly secured thereto; a spring mounted on the support between the two pegs; the spring and the pegs being arranged such that a wire passing in a predetermined path over and/or under the spring and the pegs is deflected from its normal position and exerts a pressure on the spring in a predetermined direction; a displacement measuring device associated with the spring and adapted to measure the displacement of the spring when a wire is in said predetermined path; preprogrammed computing means electrically connected to the displacement measuring device and adapted to display upon a read out a reading for the tension upon the wire when the wire is in said predetermined path; the computing means being connectable to a fully portable electrical power source.

2. The apparatus as claimed in claim 1, wherein each peg is independently selected from the group consisting of: protrusion, notch, hook, slot.

3. The apparatus as claimed in claim 1, wherein a housing for the fully portable electrical power source is incorporated in the support.

4. The apparatus as claimed in claim 1, wherein both pegs lie in the same plane, at the same level in that plane, and the spring is at a higher level than the pegs in that plane.

5. The apparatus as claimed in claim 1, wherein the pegs are at different levels in the same plane.

6. The apparatus as claimed in claim 5, wherein said predetermined path for a wire to be tested is under the lower peg and over the upper peg, passing over the upper surface of the spring.

7. The apparatus as claimed in claim 1, wherein the support is an elongated member with a handle portion at one end, the length of the handle portion being inclined at an acute angle to the length of the remainder of the support.

8. The apparatus as claimed in claim 7, wherein at least the handle portion of the support is hollow to provide a housing for the fully portable electrical power source.

9. The apparatus as claimed in claim 7, wherein the pegs are spaced along the length of the support, and are secured to the support at different levels in a plane parallel to the plane of the support.

10. The apparatus as claimed in claim 9 wherein at least one of said pegs is a hook.

11. The apparatus as claimed in claim 1 wherein the spring has a flexibility in the range 0.0016 mm/Newton-0.043 mm/Newton.

12. The apparatus as claimed in claim 1 wherein the displacement measuring device is selected from the group consisting of: strain gauge, load cell, potentiometer (linear or rotary), encoder (linear or rotary).

13. The apparatus as claimed in claim 1, wherein the displacement measuring device comprises a strain gauge secured to that surface of the spring which is not contacted by the wire in use.
